(19) United States
(12) Patent Application Publication
(10) Pub. No.: US 2007/0005987 A1
(43) Pub. Date: Jan. 4, 2007

(54) Wireless detection and/or containment of compromised electronic devices in multiple power states

(76) Inventors: Lenitra M. Durham, Beaverton, OR (US); David M. Durham, Beaverton, OR (US); Dylan C. Larson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,986

(22) Filed: Jun. 30, 2005

(51) Int. Cl. H04L 9/00

(52) U.S. Cl. 713/185

(57) ABSTRACT

Architectures and techniques that allow an electronic platform having a Radio Frequency Identification (RFID) tag to transmit platform security status information regardless of the power state of the platform. The RFID tag contains both an external passive RF interface as well as an internal bus interface that may allow components of the host platform to communicate with the RFID tag. The embedded processing agent may provide the ability to detect that a system has come under attack and cause suspicious traffic to be blocked.

### TECHNICAL FIELD

Embodiments of the invention relate to network security. More particularly, embodiments of the invention relate to wireless techniques to detect and/or contain compromised electronic devices regardless of their power states.

### BACKGROUND

A continuous stream of operating systems and application vulnerabilities has put businesses of all sizes under a constant threat of attack. In recent years, these attacks have grown increasingly sophisticated-now using multimodal attack vectors to exploit systems and spread rapidly. The attacks have also become so virulent that they can spread unabated throughout the enterprise in a matter of seconds.

In 2001, the Code Red worm is believed to have spread around the world in less than nine hours, two years later SQL Slammer spread around the world in 15 minutes. Network-borne worm and virus (a.k.a. malware) attacks may be devastating to business operations both in the damage to user productivity and in the substantial cost for the cleanup and containment of infected systems.

A single infected system connecting to an enterprise network has the potential to infect hundreds or thousands of other systems. Keeping infected systems off of corporate networks is critical to limiting the spread of the attack. Early notification of the existence of malware is critical.

Currently, when an electronic device is disconnected from a network, for example, a corporate network, that device may be subsequently infected with malware before being reconnected to the network. If the malware is not detected before the electronic device is reconnected to the network, the malware may be distributed over the network before the malware can be detected and/or the electronic device may be isolated. For example, if an employee takes a corporate laptop computer home, the corporate laptop may become infected when connected to the user's home network. Subsequent reconnection to the corporate network may release a malware attack on the corporate network.

Furthermore, spyware, viruses, and other malicious programs may be installed on a computer that can steal secret information and send it over a covert network channel. These threats demonstrate the need to detect potentially compromised systems early is very important, before they can connect to a corporate or otherwise secure network.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an electronic system.

FIG. 2 is a block diagram of one embodiment of interaction of a mobile computer system having a RFID interface and a host network having a RFID reader to determine the security status of the mobile computer system.

FIG. 3 is a flow diagram of one embodiment of a technique to detect and contain electronic devices based on security status.

FIG. 4 is a block diagram of one embodiment of a network with a secure subnetwork (subnet) partition.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are architectures and techniques that allow an electronic platform having, for example, a Radio Frequency Identification (RFID) tag, an embedded processing agent (or Embedded processing agent) and packet filtering (or network traffic control) technology to manage network access based, at least in part, on a last known security status regardless of the power state of the host platform. In one embodiment, the RFID tag contains both an external passive RF interface as well as an internal bus interface that may allow components of the host platform to communicate with the RFID tag.

The embedded processing agent or embedded processing agent may be logically or physically independent from the host system software so that it may work independently of the host, and remain unaffected and operational even when the host is damaged, attacked or compromised. In one embodiment, the embedded processing agent may provide the ability to detect that a system has come under attack and the network packet filtering technology may cause suspicious network traffic to be blocked.

Radio Frequency Identification (RFID) refers to technologies that may provide non-contact, non-line-of-sight identification. In general, RFID systems may include three components, an antenna or coil, a transceiver (with decoder), and a transponder (RF tag) in the host platform that may be electronically programmed with information.

The antenna sends out radio signals that may activate the RF tag allowing data to be read and possibly written to electronically erasable programmable memory (EEPROM) coupled with the tag. RFID tags can be read-only or read/write and can be read or written to through a variety of substances where barcodes or other optically read technologies would be ineffective. The antenna can be packaged with the transceiver and decoder to become an interrogator, typically called a reader even though it may write to writeable tags as well. RFID tags are categorized as either active or passive. Passive RFID tags obtain power from the reader and operate without a separate external power source while an internal battery powers active tags.

Combining the RFID tag with the embedded processing agent and network traffic control may allow for the early notification and/or containment of a compromised system. When the embedded processing agent deems that its host system may be compromised this information may be communicated to the RFID tag. Also, the network circuit breaker may, for example, install firewall filters to block traffic that could be used to spread the attack.

In one embodiment, when the host system is passed through an RFID portal it may be identified as being compromised regardless of the power state of host platform because the security status of the host platform has been communicated to the RFID tag. The host system can then be placed, for example, in a logical remediation area until security compliance can be determined.

In one embodiment, instructions may be written to the RFID memory by the portal to establish how the system should behave when it restarts. The embedded processor with control over the host platforms hardware may be responsible for executing these instructions to assure the host system will behave as expected. In one embodiment, this may prevent the spread of malware to a corporate network. In another embodiment, this may prevent access to the platform via removable media such as a USB device or floppy disk so as to avoid spread of a computer virus. In another embodiment, the RFID tag may alert the portal of a potentially compromised system, which in turn, may alert a human or another computer of this discovery.

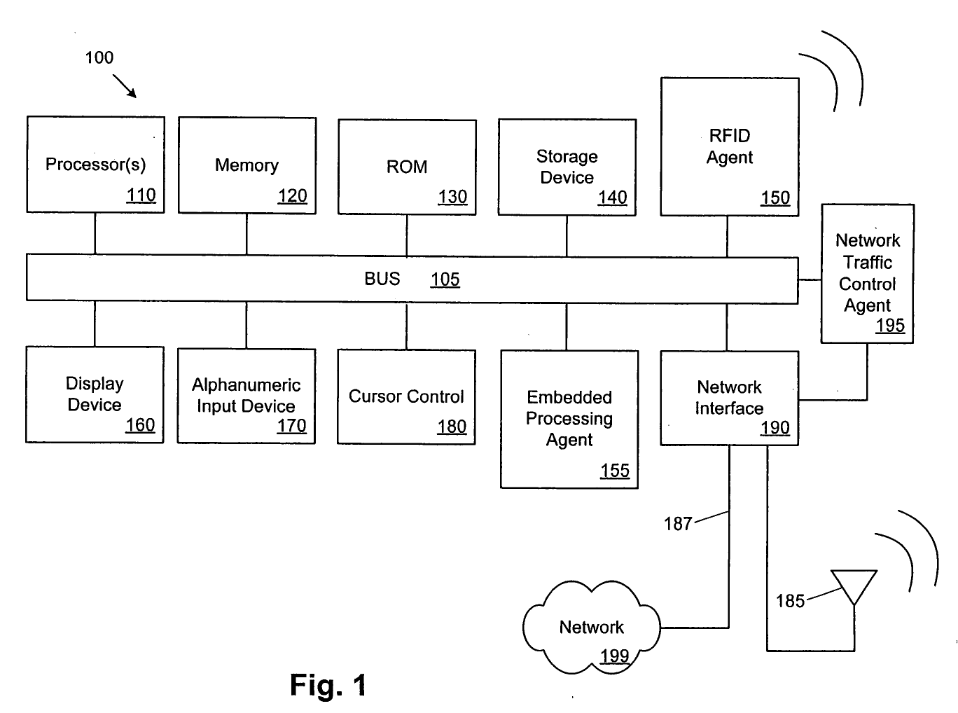

FIG. 1 is a block diagram of one embodiment of an electronic system that may include a RFID tag, an embedded processor with control over its host system's hardware components, and network packet filtering agent also under the control of the embedded processor. The architecture of FIG. 1 may allow detection of the security profile of electronic system 100 regardless of the power state of electronic system 100. The electronic system illustrated in FIG. 1 is intended to represent a range of electronic systems. Alternative electronic systems can include more, fewer and/or different components.

Described herein are architectures in which a RFID tag (e.g., as part of RFID agent 150) may be incorporated within a host electronic platform, such as a mobile computer system, a cellular-enabled device (e.g., cellular telephone, “smart” phone), a personal digital assistant (PDA), or other electronic device. In one embodiment, the RFID tag may interface with the host platform such that tag memory may also be read or written to by components of the host platform or an embedded processing agent. In one embodiment, the RFID tag memory may be divided into two parts, one that may only be written to using the host platform interface and another that may be written to using either the host platform interface or RF interface. Both parts may be readable using either the serial or RF interfaces.

Electronic system 100 may include bus 105 or other communication device to communicate information, and processor 110 coupled to bus 105 to process information. While electronic system 100 is illustrated with a single processor, electronic system 100 may include multiple processors and/or co-processors. Electronic system 100 further may include random access memory (RAM) or other dynamic storage device (referred to as memory) 120, coupled to bus 105 to store information and instructions to be executed by processor 110. Memory 120 may also be used to store temporary variables or other intermediate information during execution of instructions by processor 110.

Electronic system 100 also may include read only memory (ROM) and/or other static storage device 130 coupled to bus 105 to store static information and instructions for processor 110. Data storage device 140 such as a magnetic disk or optical disc and corresponding drive may be coupled to electronic system 100 to store information and/or instructions.

In one embodiment, electronic system 100 may include RFID agent 150, which may provide the functionality of an RFID tag, or RFID receiver as described above. RFID tag agent 150 may include a software component, a hardware element, firmware or any combination thereof. RFID tag agent 150 may operate in any manner known in the art for power-scavenging receivers to receive radiation from a transmitting device.

Electronic system 100 may also include display device 160, such as a cathode ray tube (CRT) or liquid crystal display (LCD), to display information to a user. Alphanumeric input device 170, including alphanumeric and other keys, may be coupled to bus 105 to communicate information and command selections to processor 110. Another type of user input device may be cursor control 180, such as a mouse, a trackball, or cursor direction keys to communicate direction information and command selections to processor 110 and to control cursor movement on display 160. Electronic system 100 may further include a network interface, which may be implemented as a wired (via network cable 187) and/or wireless (via antenna(e) 185) network interface 190 to provide access to a network, such as a local area network.

In one embodiment, electronic system may include embedded processor agent 155 coupled with bus 105. embedded processing agent 155 may include sufficient functionality to detect the characteristics of one or more hardware components and/or software of electronic system 100. In one embodiment, embedded processing agent 155 may be an embedded firmware agent; however, the functionality described for embedded processing agent 155 may be implemented as hardware, software, firmware, or any combination thereof. Functionality that may be provided by embedded processing agent 155 is described in greater detail below.

Components of electronic system 100 or embedded processing agent 155 may detect when there has been an exploit to the system or may detect when electronic system 100 has been used in a way that violates security policies. For example, embedded processing agent 155 may detect when electronic system 100 has been booted from an untrusted media source such as a floppy disk, Universal Serial Bus (USB) device, or compact disc (CD), which might have introduced malware or other unauthorized functionality. Alternatively, the embedded processing agent 155 may use network traffic filters to determine that the host communicated with systems or services not allowed as defined by corporate policy.

Likewise, embedded processing agent 155 may detect that a mobile host platform has been connected to an insecure network while outside a home network that may have left the host platform compromised by a worm or intrusion. Also, embedded processing agent 155 may detect that the platform's software has been modified or security agents running on the platform were modified. Additionally, embedded processing agent 155 may scan host memory (RAM), fixed or removable storage in search of virus signatures in order to determine the existence of malicious software on the system. This information may be communicated by, for example, embedded processing agent 155 to RFID agent 150 using the host platform interface and may be used by the a security entity to wirelessly determine that electronic system 100 has possibly been compromised before it is given network access.

In one embodiment, the compromised alert information may written to a read-only portion of RFID tag agent 150 memory to insure that the alert information is not overwritten by information from an RFID reader (external to electronic system 100 and not illustrated in FIG. 1). Network traffic control agent 195 may be coupled with network interface and/or bus 105.

In one embodiment network traffic control agent 195 may be used to restrict the electronic system 100 from connecting to network 199 if an exploit was detected by embedded processing agent 155 (or other system component) by, for example, installing firewall filters to block traffic that could be used to attack other network devices. Network traffic control agent 195 may completely prevent all network traffic, or may restrict network traffic to specific servers or services that can be used to repair the device. This combination of technologies may allow for wireless notification of compromised system even when electronic system 100 is powered off.

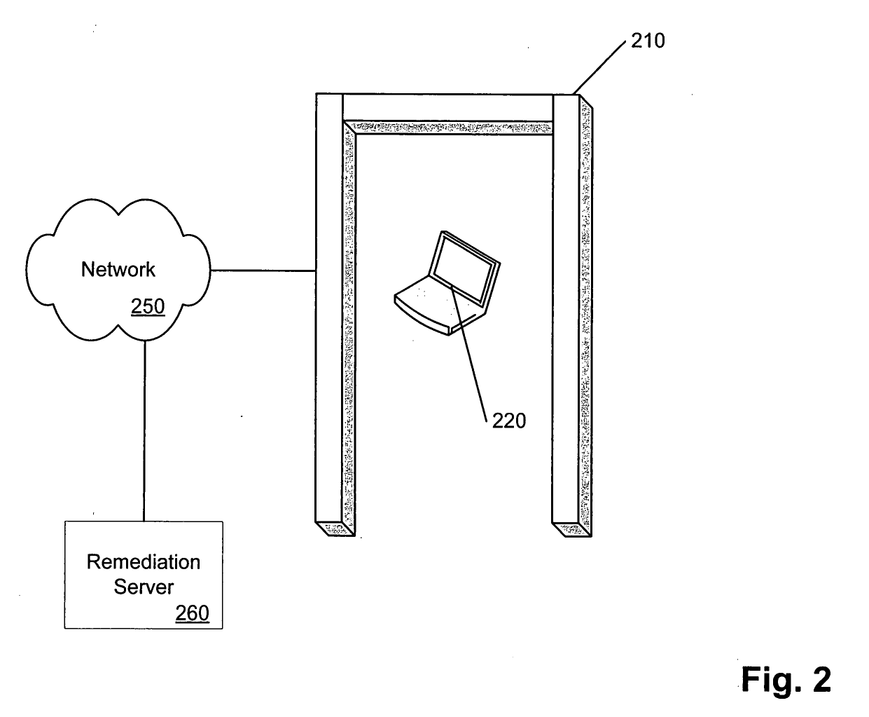

FIG. 2 is a block diagram of one embodiment of interaction of a mobile computer system having a RFID interface and a host network having a RFID reader to determine the security status of the mobile computer system. RFID reader 210 may be any type of RFID reader known in the art. While only a single RFID reader is illustrated in FIG. 2, any number of RFID readers may be coupled with network 250.

Prior to interacting with RFID reader 210 one or more components of mobile computer system 220 may analyze the security profile of computer system 200. For example, a embedded processing agent may determine that mobile computer system 220 has been infected by malware, a virus or network worm. The status of mobile computer system 220 may be written to a memory accessible by a RFID transmitter (or transceiver) within mobile computer system 220.

When mobile computer system 220 comes within close proximity of RFID reader 210, RFID reader 210 may determine the security status of mobile computer system 220. In one embodiment, the security status may be transmitted to RFID reader 210, which may then be transmitted to remediation server 260 via network 250. In an alternate embodiment, actions to be taken by mobile computer system 220 based on the security status may be transmitted to mobile computer system 220 by RFID reader 210. Combinations of these two embodiments may also be supported.

In response to determining the security status of mobile computer system 220, access to network 250 may be limited for mobile computer system 220, if the security status is suspect or unacceptable. The network access may be limited by mobile computer system 200 (e.g., network traffic control agent 195) or by a network device (e.g., a network router).

In one embodiment, if the security status is suspect or unacceptable, mobile computer system 200 is limited to having access to remediation server 260 until the security status of mobile computer system 220 can be changed to acceptable. Remediation server 260 may provide, for example, virus detection and removal services, firewall updates, operating system patches, as well as other security-related services.

Note that because the security status may be communicated via RFID protocols regardless of the power state of mobile computer system 220. Thus, mobile computer system 220 may be quarantined, or placed in the remediation network, prior to powering up of mobile computer system 220. This may allow security analysis and action before mobile computer system 220 attempts to access network 250, which may provide improved network security as compared to other security techniques. In addition, the RFID can allow a potentially compromised system to be easily located by personnel who may manually access and repair the system.

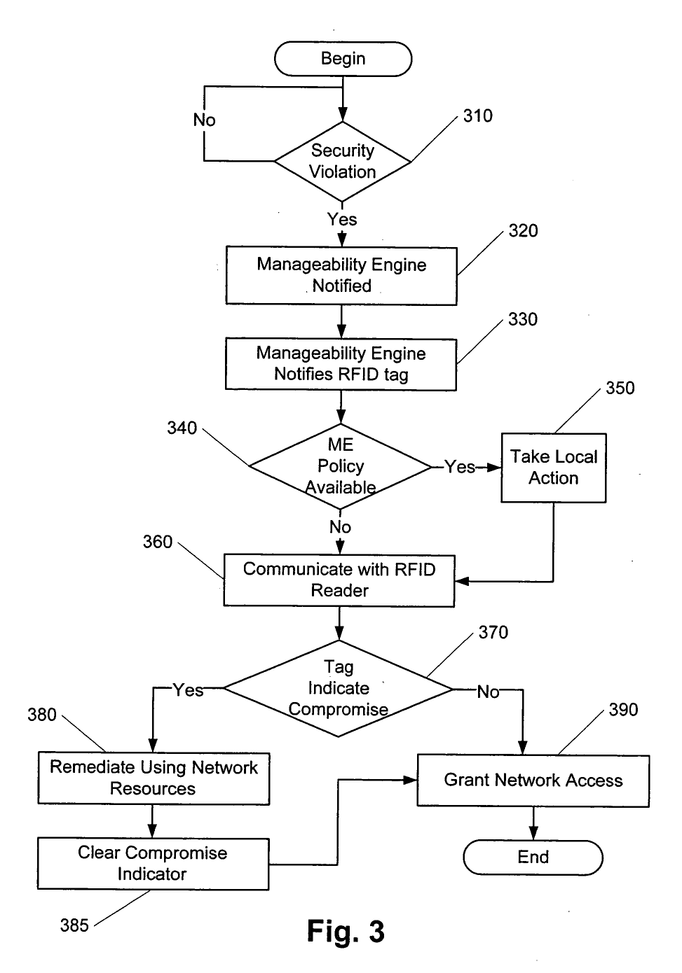

FIG. 3 is a flow diagram of one embodiment of a technique to detect and contain electronic devices based on security status. The example of FIG. 3 is presented in a specific order; however, in alternate embodiments other orderings may be used.

In one embodiment, an electronic device may have one or more components for determining whether a security violation has occurred, 310. These components may be implemented as hardware, software, firmware or any combination thereof. A security violation may include, for example, infection by malware, suspicious activity (e.g., excessive attempt at network communications, excessive disk accesses, excessive processor usage), booting of the device from an unknown or unsecured source, access to or from unknown or restricted network resources. Additional and/or different security violations may also be supported.

Security violations may be detected by software and/or other system components that periodically (or continuously) monitors device characteristics to determine whether the characteristics are within preset operational parameters. For example, a software component may determine whether the most recent operating system security patches have been installed and, if not, indicate a security violation. An embedded firmware agent may monitor network traffic to determine whether unauthorized network resources have been accessed. These are merely a few examples of the security violations that may be detected.

In one embodiment, in response to detecting a security violation, the system component that detected the security violation may notify the embedded processing agent, 320. Notification to the embedded processing agent may be accomplished in any manner known in the art. For example, interrupts may be used, or messages may be passed between software agents, etc. In another embodiment, the embedded processing agent may directly measure the host platform by scanning memory or other media. This method would allow the embedded processing agent to directly detect security violations on the system.

Upon receiving the security violation notification, the embedded processing agent may write to the RFID memory information corresponding to the security violation, 330. As discussed above, the embedded processing agent may use a memory interface that is restricted to access by the embedded processing agent and/or other selected system components, which may improve overall system security.

If the embedded processing agent has access to a security policy relevant to the detected security violation, 340, the electronic device may take local action to remediate the security violation, 350. For example, the electronic device may have a filter that may operate to limit network access, or prevent network access (e.g., network traffic control agent 195). The electronic device may switch to accessing a pre-selected virtual local area network (VLAN).

Other local actions that may be taken, 350, may include, for example, disabling a hard drive, disabling a floppy disk drive, disabling one or more buses, disabling (or locking) removable media, forcing the device to a sleep or other low power state, forcing the device to reboot in a safe or firmware mode. Other local actions may also be supported.

The security violation may be communicated to the RFID tag, which may transmit information corresponding to the security violation to an external RFID reader, 360. The RFID reader may be, for example, a portal located near entrances to a corporate building, ceiling and/or wall readers located in a building, a hand-held reader operated by a network administrator, or any other type of RFID reader, and any combination thereof. Because the RFID reader may communicate with the REID tag in the electronic device, the security status of the electronic device may be determined regardless of the power state of the electronic device. This may allow remediation efforts to begin before or upon power-up of the electronic device, which may provide greater network security as compared to more reactive strategies. This will also allow for the device to be physically prevented from entering secure locations by not unlocking doors or indicating the problem to security personnel.

If the RFID tag does not indicate a compromised electronic device, 370, network access may be granted, 390. In one embodiment, the network access granted to an electronic device that has not been compromised may be the complete network access that is ordinarily granted to a user of the electronic device and may differ depending on the specific user.

If the RFID tag does indicate a compromised electronic device, 370, network resources may be used to remediate the electronic device, 380. In one embodiment, the electronic device is granted access to a subset of the network, which may be as little as a single server. In another embodiment, the type of traffic may be limited regardless of the source or destination of the traffic. For example, the electronic device may be allowed to communicate only with a pre-specified remediation server that provides diagnostic and/or repair functionality. Further, the electronic device may be limited to responding to commands from the remediation server. As another example, a message may be transmitted to a network administrator that physically travels to the compromised electronic device to initiate remediation. As another example, a compromised device can be physically prevented from entering a building where a portal will not open a door or allow access when the RFID is relaying information about a possibly compromised system.

Regardless of the type of remediation, when the electronic device has been restored to meet network security guidelines, the compromise indicator in the RFID tag may be cleared, 385. As discussed above, for security purposes, only limited access may be granted to the RFID tag and/or the RFID tag memory so that malware may be restricted from clearing the compromise indicator. After the compromise indicator is cleared, 385, the electronic device may be granted network access, 390.

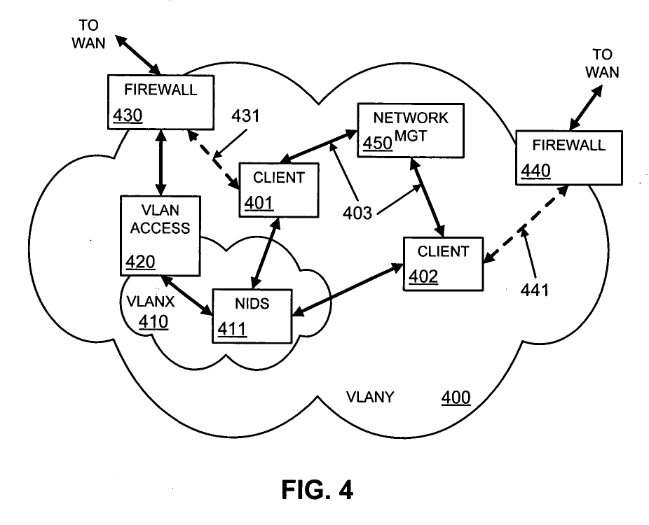

FIG. 4 is a block diagram of one embodiment of a network with a secure sub-network (subnet) partition. Virtual local area network Y (VLANY) 400 (generically “the network”) may represent a network or a network partition. VLANY 400 may be, for example, an enterprise network. Because VLANY 400 is a virtual LAN, the nodes in VLANY 400 may or may not be located physically in the same place. While the example of FIG. 4 is directed to VLANs, a similar approach may be applied to physical LANs. In one embodiment VLANY 400 represents all or part of a physical network that is defined at a management level to be a virtual network.

In one embodiment the network is subdivided/segmented/partitioned into multiple separate virtual segments/subnets. For example, a network administrator can partition the network into different VLANs via network infrastructure devices/tools that support this capability. For purposes of illustration, and not by way of limitation, FIG. 4 illustrates two partitions, VLANY 400 and VLANX 410. More partitions may be used.

For example, there may be a VLAN that handles critical vulnerabilities, one that handles moderate risk vulnerabilities, one for low risk vulnerabilities, and a main VLAN that is considered free of vulnerabilities. The security status of an electronic device as indicated by an integrated RFID tag may be used to determine the VLAN partition to which an electronic device is granted access. In one embodiment all network nodes except guest nodes are associated with either VLANY 400 or VLANX 410 based, at least in part, on security status.

In one embodiment VLANY 400 represents a VLAN of systems considered to be safe, or free from vulnerabilities. These systems may be granted greater access to network resources whether within or without VLANY 400. In one embodiment VLANX 410 represents a VLAN of systems considered to be potential vulnerability threats as indicated, at least in part, by integrated RFID tags. Thus, systems of VLANX 410 may be limited in access to network resources. For example, VLANX 410 may include one or more components to execute intrusion detection. Network intrusion detection system (NIDS) 411 represents the one or more components for detecting intrusion/protecting against intrusion. NIDS 411 may monitor traffic packets, identify users and/or targets, and signal breaches and/or potential breaches.

VLANX 410 may have a VLAN access point 420, which may represent a secure gateway, switch, router, and/or server, and may include a firewall. VLAN access 420 may provide additional security to prevent attack against or from a node in the network. Furthermore, VLAN access 420 may provide a mechanism for isolating VLANX 410 from VLANY 400. For example, traffic through (transmit and/or receive) VLAN access 420 may be restricted to prevent attack traffic from reaching nodes of VLANY 400. Nodes in VLANY 400 may also be prevented direct and/or indirect access to VLANX 410 and nodes within it. VLANX 400 may be considered a remedial subnet, a restricted area, etc.

Clients 401 and 402 may represent a variety of electronic systems, devices, machines, or apparatuses. For example, clients 401 and 402 may include a personal computer (desktop, laptop, palmtop), a server, a handheld computing device, personal digital assistant (PDA), wireless computing device, cellular phone, game console, set-top box, etc. The access of clients 401 and 402 may include wired and/or wireless connections with a routing/switching/access point on the network. Clients 401 and 402 may be a terminating or user devices of a network.

At a platform level of clients 401 and 402, the systems may include the ability to detect system characteristics like device information, operating system version, applied patches, details of applications installed on the machine, etc. One example includes using hooks into the OS to obtain this information. Alternatively, or in addition, a BIOS may be accessed/queried for information. As discussed above, this information may be stored in memory of a RFID tag that is accessible only to authorized and authenticated entities.

For purposes of example, client 401 will be described as a mobile (e.g., portable, a laptop, configurable to be easily removable from the network) node, and client 402 will represent a stationary (e.g., not easily removable, a desktop) node. Clients 401 and 402 may be nodes that will interact (e.g., transmit/receive/exchange traffic) over the network and/or with devices outside the network with one or more of various supported communication protocols. In one embodiment, clients 401 and 402 include platforms owned by the enterprise associated with the network. The network policy may include specifications for access, restrictions and/or limitations on use of the network, etc.

In one embodiment client 401 is introduced into the network. For example, client 401 may be connected for a first time, or client 401 may have left the network and later returned. As client 401 is brought within the physical boundaries that the network serves, the security status of client 401 may be determined by one or more RFID readers. If the client 401 has fallen out of compliance, or in one embodiment, the mere fact that the machine accessed an unknown and/or non-secure network may cause the machine to be flagged for access through the remedial subnet.

Access of client 401 of the network through the remedial subnet may continue in either case until the security of a platform of client 401 can be corrected. Compliance may involve installing upgrades, patches, etc., on client 401. Thus, either as a new client, or as a returning client, client 401 may then be granted access to VLANY 400. Another approach when client 401 rejoins the network may be to not allow the client 401 to access the network until remediation is completed, rather than redirecting its traffic over a separate VLAN.

In one embodiment client 402 represents a stationary client. While the condition that client 402 accessed another network may be unusual or unlikely, other factors may cause client 402 to be considered a potentially vulnerable node. In the case of either client 401 or client 402, if a new security patch has been announced, if the client does not have the latest security patch, the client could be considered potentially vulnerable. Thus, client 402 and client 401 may periodically report compliance with security patch updates via RFID protocols as described above.

In one embodiment network management 450 represents one or more management elements on the network, for example, a remediation server. This may include as one element, or as part of an element, a vulnerability database cross indexer/security database/policy decision point. A network administrator may maintain a database of known vulnerabilities of different applications and operating systems. For example, this information is typically available on various websites, and can be generally easily obtained. The vulnerability database and/or a function of network management 450 may be to cross-index the information with the machine characteristics sent by the machines currently on the network. A list of vulnerable machines and level of the threat can be determined and used to isolate these machines in VLANX 410.

As RFID tags may also be written to by the RFID reader, instructions can be downloaded to the RFID tag regardless of power state. Thus, once a RFID portal has read the contents of a device's RFID, the portal may contact a backend server with this information, which may produce a list of instructions that will be written to the device's RFID tab. These instructions may then be interpreted by the embedded processing agent or other component on the device. Instructions may include, for example, IT policy, VLAN information, packet filters that should be applied to network traffic, media that may be disabled or disallowed, information on virus/worm signatures for which the system should be scanned, and any other policy or actions that should be taken in response to the condition of the system relayed via the RFID. Entire programs may be written to the RFID tag memory and executed by an entity on the system such as the embedded processing agent.

When writing to the RFID tag memory of the device, security measures may be in place to restrict what information would be accepted. In one embodiment, the information written to the RFID tag memory can be signed by an authorized entity, and this signature can be verified by the embedded processing agent or other component that has access to information written to the RFID tag. This information can be signed with a secret key shared between the embedded processing agent and authorized entity, or using public/private key cryptography where only the authority has access to the private key while the device embedded processing agent, or verifying entity, has access to the public key information or signing authority information needed to verify the signature and, thus, authenticity of the information written to the RFID tag memory. Once the information written to the RFID tag memory has been verified as authentic and having come from a trusted source, this information may then be acted upon by the embedded processing agent or other entity in the system.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
determining a security status of an electronic device; and
transmitting the security status to an external device using a transmitter configured to operate according to a power-scavenging protocol.

2. The method of claim 1 wherein the power-scavenging transmitter comprises a radio frequency identification (RFID) transceiver.

3. The method of claim 2 further comprising storing the security status in a memory associated with the RFID transceiver via a secure interface.

4. The method of claim 3 further comprising verification of the security status received by the RFID transceiver.

5. The method of claim 2 further comprising:
receiving instructions from a remote RFID portal via the RFID transceiver; and
conveying the instructions to an embedded processing agent coupled with the RFID transceiver.

6. The method of claim 5 further comprising verification of the security status received by the RFID transceiver.

7. The method of claim 1 further comprising selectively limiting access to network resources based, at least in part, on the security status transmitted to the external device.

8. The method of claim 7 wherein the external device comprises a radio frequency identification (RFID) reader and selectively limiting access to network resources comprises:
determining a security violation based, at least in part, on the security status transmitted to the RFID reader;
restricting access to one or more network resources based, at least in part, on the security violation; and
determining one or more remediation actions to be taken based, at least in part, on the security violation.

9. The method of claim 8 wherein restricting access to one or more network resources comprises one or more network routing devices restricting access to one or more network accesses based, at least in part, on the security violation.

10. The method of claim 8 wherein restricting access to one or more network resources comprises one or more filters on the electronic device restricting access to one or more network accesses based, at least in part, on the security violation.

11. The method of claim 8 wherein a security violation comprises one or more of: detection of malware on the electronic device, lack of current security patch installation, bootup of the electronic device from an unauthorized source, access to unauthorized network resources.

12. The method of claim 1 wherein further comprising taking local remediation actions with components of the electronic device based, at least in part, on the security status.

13. The method of claim 12 wherein the local remediation actions comprise one or more of: disabling a hard drive, disabling a floppy disk drive, disabling one or more buses, locking removable media, forcing the device to a sleep or other low power state, forcing the device to reboot in a safe or firmware mode.

14. An apparatus comprising:
one or more components interconnected to provide functionality to an electronic device, wherein at least one of the components is configured to detect and report a security violation within the electronic device;
a network interface coupled with at least one of the components to provide access to remote network devices;
a embedded processing agent coupled with one or more of the components to receive the report of the security violation; and
a transmitter coupled with the embedded processing agent to transmit information corresponding to the security violation using a power-scavenging wireless communication protocol.

15. The apparatus of claim 14 wherein the transmitter comprises a radio frequency identification (RFID) transmitter.

16. The apparatus of claim 14 wherein the network interface comprises a filter that is configurable to limit access to remote devices via the network interface based, at least in part, on the security violation.

17. The apparatus of claim 14 wherein the connection between the embedded processing agent and the transmitter comprises a secure connection.

18. The apparatus of claim 14 wherein the embedded processing agent causes local remediation actions to be taken in response to the security violation.

19. The apparatus of claim 18 wherein the local remediation actions comprise one or more of: disabling a hard drive, disabling a floppy disk drive, disabling one or more buses, locking removable media, forcing the device to a sleep or other low power state, forcing the device to reboot in a safe or firmware mode.

20. A system comprising:
one or more components interconnected to provide functionality to an electronic device, wherein at least one of the components is configured to detect and report a security violation within the electronic device;
a network interface coupled with at least one of the components to provide access to remote network devices;
an Ethernet cable coupled with the network interface;
a embedded processing agent coupled with one or more of the components to receive the report of the security violation; and
a transmitter coupled with the embedded processing agent to transmit information corresponding to the security violation using a power-scavenging wireless communication protocol.

21. The system of claim 20 wherein the transmitter comprises a radio frequency identification (RFID) transmitter.

22. The system of claim 20 wherein the network interface comprises a filter that is configurable to limit access to remote devices via the network interface based, at least in part, on the security violation.

23. The system of claim 20 wherein the connection between the embedded processing agent and the transmitter comprises a secure connection.

24. The system of claim 20 wherein the embedded processing agent causes local remediation actions to be taken in response to the security violation.

25. The system of claim 20 wherein the local remediation actions comprise one or more of: disabling a hard drive, disabling a floppy disk drive, disabling one or more buses, locking removable media, forcing the device to a sleep or other low power state, forcing the device to reboot in a safe or firmware mode.

26. An article comprising a computer-readable medium having stored thereon instructions that, when executed, cause one or more processors to:
determine a security status of an electronic device; and
transmit the security status to an external device using a transmitter configured to operate according to a power-scavenging protocol.

27. The article of claim 26 wherein the power-scavenging transmitter comprises a radio frequency identification (RFID) transceiver.

28. The article of claim 27 further comprising instructions that, when executed, cause the one or more processors to store the security status in a memory associated with the RFID transceiver via a secure interface.

29. The article of claim 28 further comprising instructions that, when executed, cause the one or more processors to verify the security status received by the RFID transceiver.

30. The article of claim 27 further comprising instructions that, when executed, cause the one or more processors to:
receive instructions from a remote RFID portal via the RFID transceiver; and
convey the instructions to an embedded processing agent coupled with the RFID transceiver.

31. The article of claim 30 further comprising instructions that, when executed, cause the one or more processors to verify the security status received by the RFID transceiver.

32. The article of claim 26 further comprising instructions that, when executed, cause the one or more processors to selectively limit access to network resources based, at least in part, on the security status transmitted to the external device.

33. The article of claim 32 wherein the external device comprises a radio frequency identification (RFID) reader and the instructions that cause the one or more processors to selectively limit access to network resources comprise instructions that, when executed, cause the one or more processors to:
determine a security violation based, at least in part, on the security status transmitted to the RFID reader;
restrict access to one or more network resources based, at least in part, on the security violation; and
determine one or more remediation actions to be taken based, at least in part, on the security violation.

34. The article of claim 33 wherein the instructions that cause the one or more processors to restrict access to one or more network resources comprise instructions that, when executed, cause one or more network routing devices to restrict access to one or more network accesses based, at least in part, on the security violation.

35. The article of claim 33 wherein the instructions that cause the one or more processors to restrict access to one or more network resources comprise instructions that cause one or more filters on the electronic device to restrict access to one or more network accesses based, at least in part, on the security violation.

36. The article of claim 33 wherein a security violation comprises one or more of: detection of malware on the electronic device, lack of current security patch installation, bootup of the electronic device from an unauthorized source, access to unauthorized network resources.

37. The article of claim 26 further comprising instructions that, when executed, cause the one or more processors to take local remediation actions with components of the electronic device based, at least in part, on the security status.

38. The article of claim 37 wherein the local remediation actions comprise one or more of: disabling a hard drive, disabling a floppy disk drive, disabling one or more buses, locking removable media, forcing the device to a sleep or other low power state, forcing the device to reboot in a safe or firmware mode.
